(19) United States
(12) Patent Application Publication
(10) Pub. No.: US 2003/0041073 A1
(43) Pub. Date: Feb. 27, 2003

(54) Method and apparatus for reordering received messages for improved processing performance

(76) Inventor: Josh D. Collier, Winchester, MA (US)

Correspondence Address: BROMBERG & SUNSTEIN LLP, 125 SUMMER STREET, BOSTON, MA, 02110-1618, US

(21) Appl. No.: 09/934,163

(22) Filed: Aug. 21, 2001

(51) Int. Cl. G06F 12/00

(52) U.S. Cl. 707/200

(57) ABSTRACT

A method and apparatus for reordering messages received from a network that includes a number of message sources. The method includes tagging and storing incoming messages, maintaining ordered queues of messages to be processed for each sender and selecting from among the received messages for processing and dequeuing. Selecting may involve an arbitration algorithm and may first require the availability of processing resources for a message to be selected.

### TECHNICAL FIELD

The present invention relates to methods for processing data messages received from a communication network, and more particularly, to a method for efficiently handling simultaneous streams of messages from different sources.

### BACKGROUND ART

In communication networks, data messages often arrive at a node in an interleaved stream from multiple sources. The protocol for data message exchange among nodes can include strict ordering requirements on the processing of messages exchanged between two nodes. If the receiving node must wait to acquire resources, such as memory, to process a received message, these ordering requirements can impose a processing bottleneck.

One such communication network is implemented according to the Infiniband™ Architecture Specification developed by the Infiniband^{SM} Trade Association, the specification for which is incorporated herein by reference (Infiniband™ Architecture Specification, version 1.0). The Infiniband™ Architecture defines a system area network for connecting multiple independent processor platforms (i.e., host processor nodes), input/output (“IO”) platforms, and IO devices as is shown in FIG. 1. The system 100 is a communications and management infrastructure supporting both IO and interprocessor communications for one or more computer systems. The system 100 can range from a small server with one processor and a few IO devices to a massively parallel supercomputer installation with hundreds of processors and thousands of IO devices. Communication among nodes is accomplished according to an Infiniband™ protocol. In addition, the IP (Internet protocol) friendly nature of the architecture allows bridging to an Internet, intranet, or connection to remote computer systems 111.

The Infiniband™ architecture defines a switched communications fabric 101 allowing many devices to concurrently communicate with high bandwidth and low latency in a protected, remotely managed environment. The system 100 consists of processor nodes 102, 103, and 104 and IO units 105, 106, 107, and 108 connected through the fabric 101. The fabric is made up of cascaded switches 109 and routers 110. IO units can range in complexity from a single attached device, such as a SCSI or LAN adapter to large memory rich RAID subsystems 107.

The foundation of the Infiniband™ operation is the ability of a client process to queue up a set of instructions that hardware devices or nodes, such as a channel adapter 112, switch 109, or router 110 execute. This facility is referred to as a work queue. Work queues are always created in pairs consisting of a send work queue and a receive work queue. The send work queue holds instructions that cause data to be transferred between the client's memory and another process's memory. The receive work queue holds instructions about where to place data that is received from another process. Each node may provide a plurality of queue pairs, each of which provide independent virtual communication ports.

A queue pair can support various types of service which determine the types of messages used to communicate on that queue pair. Message types include request type messages and response type messages. Infiniband™ requires that the request messages on a queue pair be processed in a specific order. Similar ordering requirements are imposed on response messages. (See section 9.5 of the Infiniband™ Architecture Specification for ordering requirements.) Certain request message types (e.g., Send messages) require information to be fetched identifying resources so that the message can be processed. For example, a Send message requires a work queue element (“WQE”) to be fetched. The WQE specifies the list of virtual addresses where the data in the SEND message is to be stored on the receiving node. In a large system configuration the latency for the operating system (“OS”) to fetch a WQE can be quite high. If messages are processed serially as received from an Infiniband™ network, a significant performance penalty can result.

### SUMMARY OF THE INVENTION

In accordance with an embodiment of the present invention, a method is provided for reordering messages received from a communication network, for processing. A message store is provided for received messages. A plurality of FIFO queues receive tags corresponding to storage slots in the message store. A received message is enqueued for reordering by storing the message in a free slot in the message store. A FIFO queue is selected based at least on the message's source and type. A tag corresponding to the message's storage slot is then loaded onto the selected FIFO queue. When messages are ready for further processing, a FIFO queue is selected among the queues that have tags at the head of the queue that corresponding to messages that are ready for further processing. The corresponding message slot is freed and the tag is removed from the head of the selected FIFO queue.

In a specific embodiment of the present invention, messages received from an Infiniband™ network may be reordered such that all request messages or, alternatively, all response messages received from a single queue pair are processed in order. This ordering is enforced by using a FIFO queue to hold tags for all messages awaiting processing, that (1) were received on the same queue pair and (2) are of the same message type. This embodiment allows processing to proceed contemporaneously among messages received on different queue pairs and between response and request messages received on the same queue pair. This embodiment can advantageously increase message processing efficiency and reduce the latency time in processing received messages by reducing bottlenecks due to contention for resources.

A message reordering device, that is part of a node, is provided in accordance with an embodiment of the present invention. The device includes a message store, that includes a plurality of storage slots. The device further includes a plurality of FIFO tag queues. The device includes logic for enqueuing a received message. Enqueueing a received message includes storing a message in a storage slot identified by a given tag; selecting a FIFO tag queue based at least on source identifier and message type for the message; and loading the given tag onto the selected FIFO tag queue. When a message is ready for further processing, because the corresponding tag is at the head of any tag queue and the node has acquired the resources for processing the message further, logic arbitrates among the ready messages for selection. Logic frees the storage slot for the selected message and removes the tag for the message from the head of the corresponding FIFO queue.

### BRIEF DESCRIPTION OF THE DRAWINGS

The foregoing features of the invention will be more readily understood by reference to the following detailed description, taken with reference to the accompanying drawings, in which:

FIG. 1 is a block diagram illustrating a system area network in which an embodiment of the present invention may be employed;

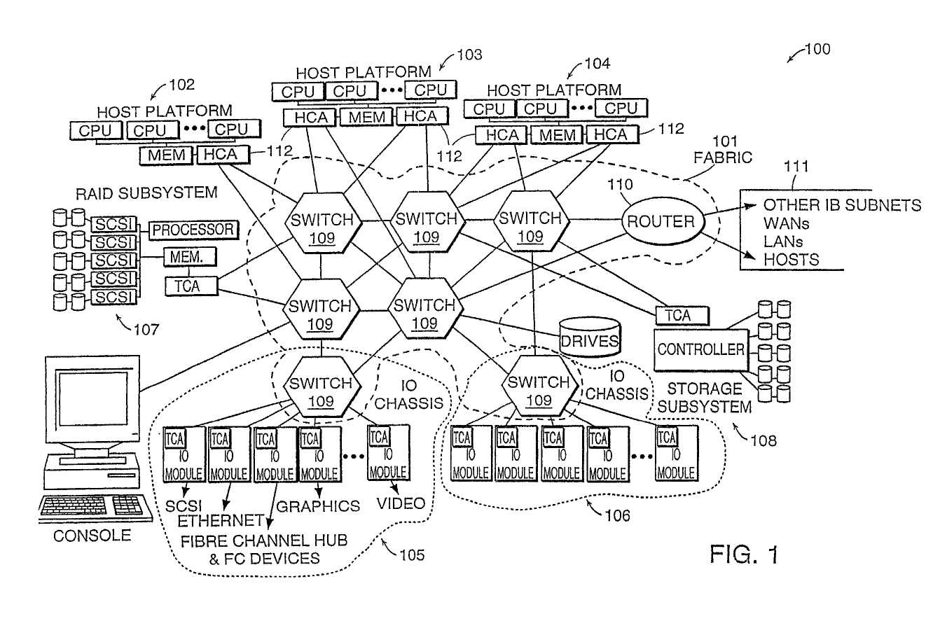

FIG. 2 is a flow chart illustrating an embodiment of the invention;

FIG. 3 is a block diagram of a message management device according to an embodiment of the present invention.

FIG. 4 is a flow chart further illustrating an embodiment of the invention.

### DETAILED DESCRIPTION OF SPECIFIC EMBODIMENTS

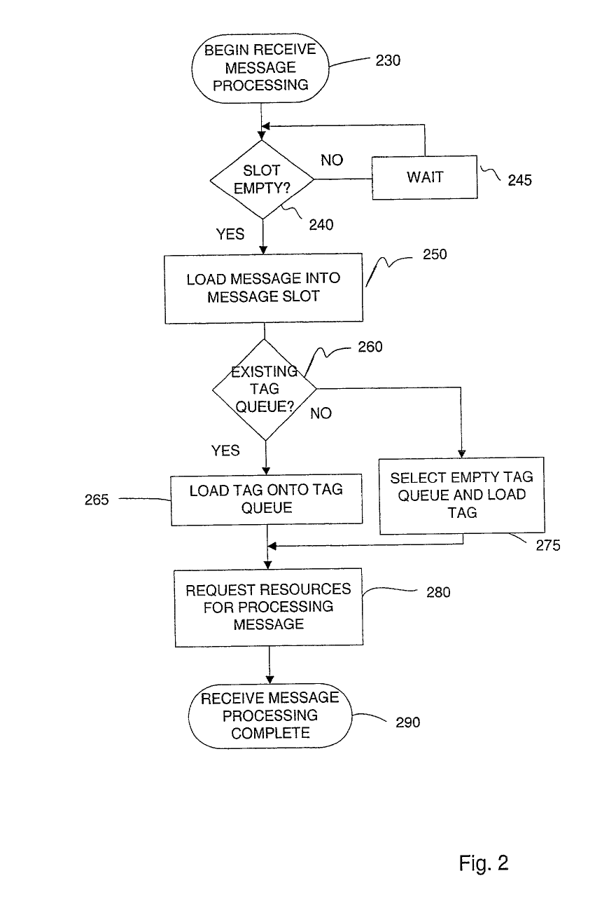

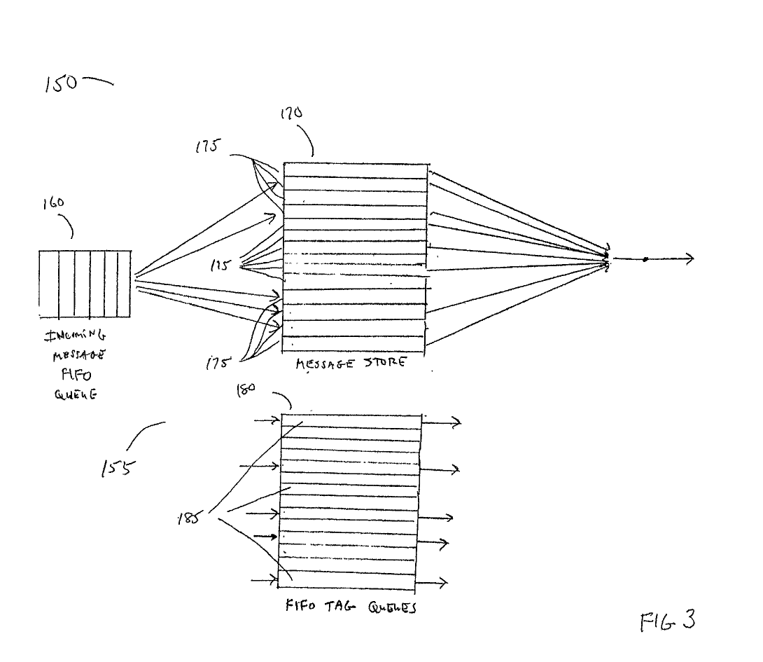

FIG. 2. is a flow chart showing a method of reordering messages received from a plurality of sending nodes, so that the stream of received messages may be processed efficiently according to an embodiment of the present invention. FIG. 3 is a block diagram of a message management device 155 employed in this method, that is part of a node 150. A node processes or forwards messages. A node, as used herein, includes an independent processor platform, an input/output platform, an I/O device or other such processing nodes. Receipt of a message at the node 150 triggers receive message processing 230, with the message initially stored in an incoming message FIFO queue 160. Logic checks 240 whether there is an empty storage location in a message store 170. The message store has a plurality of storage locations, or slots 175, for storing messages. Slots may be implemented in any storage medium, including, without limitation, volatile memory, nonvolatile memory, disk drives, optical storage, and hardware registers. If an empty slot is not available in the message store 170, slot availability is checked again after a delay time 245. When a slot is available, the message is loaded 250 into that slot. The slot is identified by a tag. A tag queue is then selected 260 from a plurality of first-in-first out (“FIFO”) tag queues. If a tag queue already has a tag corresponding to a message of the same message type that arrived from the same source, the tag is loaded onto that tag queue 265. Otherwise, the tag is loaded onto an empty tag FIFO queue 275. Logic at the node then initiates acquisition of the resources needed to process the message 280 further. For example, if the received message is a Send message in an Infiniband™ network, logic initiates the fetch of a WQE to determine where in system memory to store the incoming data. A resource needed to process a received message may include, for example, storage buffers that are shared by logic at the node among a plurality of processes. Once resource acquisition is initiated by logic at the node, the resources will become available at a later time, according to whatever method is used by the node to allocate resources. In a specific embodiment, the logic for resource allocation at the node may include an operating system. Receive message processing is then complete.

In accordance with a specific embodiment, the communication network is implemented in accordance with the Infiniband™ protocol. Each tag queue stores tags for all messages in the message store that were received on the same queue pair and are of the same type, where the type is either a request type or a response type.

In accordance with another specific embodiment, the number of FIFO tag queues is equal to the number of slots in the message store.

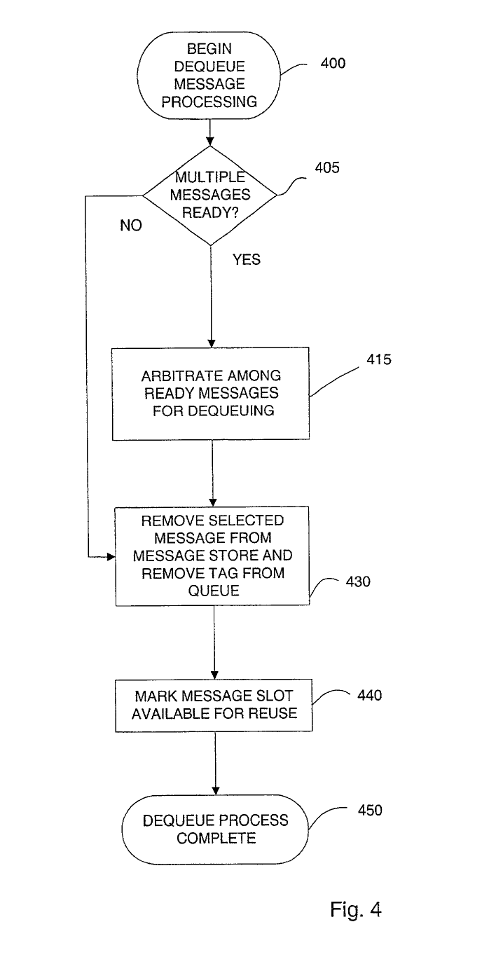

FIG. 4 shows additional steps according to an embodiment of the present invention. When logic at the node has acquired the resources needed for processing a message in the message store and the tag for the message is at the head of a FIFO tag queue 185, the message is “ready” for dequeuing. Dequeue message processing begins 400. If multiple messages are ready for dequeuing 405, a priority arbitration process 415 selects the message to be dequeued. The selected message is dequeued from the message store for further processing 430, in a later processing stage. The tag is then removed from the FIFO tag queue and the message slot is marked “available” for further received messages 440. If messages are still ready for dequeuing, the dequeuing process continues 405. If no further messages are ready for dequeueing, the dequeuing process is complete 450. This method of dequeuing the messages ensures that messages received from the same source with the same message type are processed in order, because the tags for such messages are loaded onto the same FIFO tag queue 185. The method also ensures that a delay in acquiring resources needed to process a message from a given source or of a given message type does not delay the processing of messages from other sources or of a different message type. This result follows since tags corresponding to such messages will be loaded onto different FIFO tag queues: messages whose tags are loaded onto different tag queues can be dequeued and processed in an order different from the order in which the messages were received at the node.

In accordance with a specific embodiment, the arbitration process employs a round-robin algorithm for selecting the next message for dequeuing, if multiple messages are ready for dequeuing. In the round robin approach, the FIFO tag queues are assigned an order. The next ready message dequeued will be at the head of the tag queue next in order above the tag queue for the last message dequeued. Other arbitration algorithms can be applied to select the next message to be dequeued, as are known in the art. Use of any of these arbitration algorithms is within the scope of the present invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an embodiment of the present invention, predominantly all of the reordering logic may be implemented as a set of computer program instructions that is converted into a computer executable form, stored as such in a computer readable medium, and executed by a microprocessor within the array under the control of an operating system.

Computer program logic implementing all or part of the functionality previously described herein may be embodied in various forms, including, but in no way limited to, a source code form, a computer executable form, and various intermediate forms (e.g., forms generated by an assembler, compiler, networker, or locator.) Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL.)

The present invention may be embodied in other specific forms without departing from the true scope of the invention. The described embodiments are to be considered in all respects only as illustrative and not restrictive.

What is claimed is:

1. A method for reordering messages for processing, the messages received from a communication network, each message characterized by a source identifier and type, the method comprising:
providing a message store, the message store including a plurality of storage slots;
providing a plurality of FIFO queues;
enqueuing a given message including:
storing the given message in a given storage slot identified by a given tag;
selecting one of the FIFO queues based at least on source identifier and type for the given message; and
loading the given tag onto the selected FIFO queue.

2. The method of claim 1 further including:
selecting a message for dequeuing after the tag corresponding to the message is at the head of one of the FIFO queues;
removing the tag corresponding to the selected message from the corresponding FIFO queue; and
freeing the storage slot identified by the tag corresponding to the selected message.

3. The method of claim 2 wherein selecting a message for dequeuing includes arbitrating for priority by applying a round robin priority algorithm.

4. The method of claim 2 wherein selecting a message for dequeuing further includes determining that resources are available for processing the message.

5. The method of claim 4 wherein selecting a message for dequeuing further includes arbitrating for priority.

6. The method of claim 1 wherein selecting one of the FIFO queues includes ensuring that no two FIFO queues contain tags corresponding to messages with the same source identifier and type.

7. The method of claim 1 wherein the number of FIFO queues equals the number of storage slots.

8. A method for reordering messages for processing by a node, the messages received from a communication network, each message characterized by a source identifier and type, the method comprising:
providing a message store, the message store including a plurality of storage slots, the slots storing messages;
providing a plurality of FIFO queues, the queues containing tags corresponding to storage slots;
selecting a given message for dequeuing after the tag corresponding to the given message is at the head of one of the FIFO queues;
removing the tag corresponding to the given message from the FIFO queue; and
freeing the storage slot identified by the tag.

9. A method according to claim 8, wherein selecting a given message for dequeuing further includes determining that the node has acquired resources for processing the given message.

10. A method according to claim 8, wherein selecting a given message for dequeuing further includes arbitrating for priority among messages for which the corresponding tag is at the head of one of the FIFO queues and for which the node has acquired resources for processing the given message.

11. A method according to claim 10, wherein arbitrating for priority includes applying a round robin priority algorithm.

12. A message reordering device for messages received from a communication network for processing, each message characterized by a source identifier and a type, the device comprising:
a message store, the message store including a plurality of storage slots;
a plurality of FIFO queues;
logic for enqueuing a given message including:
storing the given message in a storage slot identified by a given tag;
selecting one of the plurality of FIFO queues based at least on source identifier and type for the message; and
loading the given tag onto the selected FIFO queue.

13. The device of claim 12 further including:
logic for selecting a given message for dequeuing;
logic for removing the tag corresponding to the given message from the corresponding FIFO queue; and
logic for freeing the storage slot identified by the tag corresponding to the given message.

14. The device of claim 13, wherein logic for selecting a given message for dequeuing further includes logic for arbitrating for priority among messages for which the corresponding tag is at the head of any FIFO queue and for which the node has acquired resources for processing the message.
